(19) United States
(12) Patent Application Publication
(10) Pub. No.: US 2012/0035311 A1
(43) Pub. Date: Feb. 9, 2012

(54) COLORED BUBBLES

(75) Inventors: Jie Li, Allentown, PA (US); Leena Vadaketh, Doylestown, PA (US); Jacqueline Aseng, Bushkill, PA (US)

(73) Assignee: Crayola, LLC, Easton, PA (US)

(21) Appl. No.: 12/851,132

(22) Filed: Aug. 5, 2010

(51) Int. Cl. C08K 5/05

(52) U.S. Cl. 524/388; 524/386

(57) ABSTRACT

A colored bubble composition for producing colored bubbles having water, at least one humectant, at least one water soluble polymer, and at least one colorant. The colored bubble composition may be obtained by mixing water, at least one humectant, and at least one water soluble polymer to form a mixture, wherein the mixture does not comprise a colorant. Subsequently, at least one colorant is added to the mixture. In particular, a mixture of water, at least one humectant, and at least one water soluble polymer may be heated to a temperature in the range of about 40 to 60° C. and subsequently, cooled to about 20 to 30° C. The at least one colorant is then added to the cooled mixture.

### FIELD OF THE INVENTION

The invention relates to colored bubble compositions and the methods of making the compositions.

### BACKGROUND OF THE INVENTION

Bubbles have a long history as children's novelty toys. Traditionally, an aqueous soap solution was used to form a bubble by coating a shaped article having an opening therein, such as a wand, into the soap solution and then blowing into the opening to form bubbles. The soap has the effect of decreasing the surface tension of the water so that a film is formed across the opening of the wand. As a gas, such as air, is pushed or forced across the surface of the film in the opening, the film is displaced from the opening and a free-floating bubble is produced. The surface tension of the soap solution allows the bubble to form and float for a period of time until the bubble ruptures and the gas is released. Thus, bubbles may be generally defined as a small volume of gas, such as air, contained within the bubble solution. Bubble-forming devices may range from basic ones, such as the wand, to sophisticated devices, such as mechanized bubble-producing toys.

There are a variety of bubbles solutions available to produce many different types of bubbles, such as long-lasting bubbles, large bubbles, phase-changing bubbles, glowing bubbles, colored bubbles, etc. Colored bubbles have been formed by adding a colorant, such as a dye, to the aqueous soap solution. Depending on the amount of colorant added, varying degrees of color brilliance and opacity may be achieved. Traditionally, the ingredients of the bubble solution have been merely mixed together, for example, at room temperature. Alternatively, as described in U.S. Publication No. 2006/0004110, a solution can be formed by mixing and heating to 50° C. a solution of colorant, humectant, and water for about 15 minutes. Then, the mixture containing the colorant is cooled to room temperature.

### SUMMARY OF THE INVENTION

The present invention provides unique methods of making colored bubble compositions, which may be used to produce colored bubbles. In particular, a colored bubble composition for producing colored bubbles may be obtained by mixing water, at least one humectant, and at least one water soluble polymer to form a mixture, where the mixture does not comprise any colorants. Subsequently, at least one colorant is added to the mixture. The bubbles obtainable from such a composition may be richly and uniformly colored based on the type and amount of colorant and the conditions selected in making the bubble solution described herein.

According to one embodiment of the present invention, the at least one humectant and the at least one water soluble polymer are mixed together, and, subsequently, the water and other optional ingredients are added, except for a colorant. The colorant is added last after the components have dissolved and the mixture is homogenous.

According to another embodiment of the present invention, the colorant is added after a pre-heated mixture of water, humectant, and optional surfactant has cooled to about room temperature.

According to another embodiment of the present invention, a colored bubble composition for producing colored bubbles is obtained by: (a) heating a mixture of water and at least one humectant; (b) cooling the mixture; (c) adding at least one surfactant to the mixture; and (d) adding at least one colorant to the mixture after the mixture has cooled to about 20 to 30° C.

According to another embodiment of the present invention, a method of making a colored bubble composition for producing colored bubbles comprises: (a) heating a mixture of water and at least one humectant; (b) cooling the mixture; (c) adding at least one surfactant to the mixture; and (d) adding at least one colorant to the mixture after the mixture has cooled to about 20 to 30° C.

According to another embodiment of the present invention, a method of making a colored bubble composition for producing colored bubbles comprises (a) heating a mixture of water, at least one humectant, and an optional surfactant to a temperature in the range of about 40 to 60° C.; (b) cooling the mixture to a temperature in the range of about 20 to 30° C.; and (c) adding at least one surfactant and at least one colorant to the cooled mixture.

It was found that the bubble solutions obtained from the methods according to the present invention were more stable and the colorant remained dispersed throughout the bubble solution for a longer period of time as compared to bubble solutions of the prior art.

### DETAILED DESCRIPTION OF THE INVENTION

Aspects of the present invention include methods of making colored bubble compositions and the compositions obtained therefrom. In an embodiment of the present invention, water, at least one humectant, and at least one water soluble polymer are mixed to form a mixture, where the mixture does not comprise any colorants. Subsequently, at least one colorant is added to the mixture. For example, a colored bubble composition may be obtained by heating a mixture of water and at least one humectant and then cooling the mixture. At least one surfactant is added to the mixture, and at least one colorant is added to the mixture after the mixture has cooled to about 20 to 30° C.

As used herein, “colored bubbles” is intended to mean a bubble containing some amount of colorant. A colored bubble may vary on a scale from translucent to opaque. The colored bubble is preferably an evenly colored bubble having a saturated hue. The choice and amount of colorant and other ingredients and the process of preparing the colored bubble composition will determine the resulting color and saturation of the colored bubble. The colored bubble may be substantially and uniformly colored and may have a single color uniformly dispersed in the thin film of the bubble. In other words, the coloration in the bubble may be dispersed evenly throughout the bubble and the coloration concentration may be uniform throughout the bubble.

As used herein, unless specified otherwise, the values of the constituents or components of the compositions are expressed in weight percent or % by weight of each ingredient in the composition.

The colored bubble composition comprises water, at least one humectant, at least one water soluble polymer, and at least one colorant. The colored bubble composition is an aqueous solution comprising water. Once the other ingredients are accounted for, the balance of the bubble composition is water. The water may be of any suitable type, e.g., distilled, deionized, treated, etc. The type and amount of water is not especially limited. In an exemplary embodiment, the amount of water ranges from about 50 wt. % to about 95 wt. %, preferably about 70 wt. % to 90 wt. %, more preferably about 75 wt. % to about 85 wt. %.

The colored bubble composition comprises at least one humectant. Humectants, which help to retard the evaporation of water from the bubble composition, are generally known to those skilled in the art. Humectants are also believed to help strengthen the bubble formation, enhance even distribution of the dye throughout the bubble, and/or increase the life of the bubble in the air. Humectants may include, but are not limited to, polyhydroxy alkyls, such as glycerin, ethylene glycol, propylene glycol, diethylene glycol, polyethylene glycol, hydroxylated starches, and mixtures thereof. Any effective amount of humectant may be used although a generally useful concentration range for these humectants is from about 1% to about 20% by weight, preferably about 3 to 12% by weight, more preferably about 5 to 10% by weight of the total bubble composition.

In an exemplary embodiment, the humectant is glycerin. Glycerin is an organic compound also called glycerol or glycerine, which is a colorless, odorless, viscous liquid. Glycerin contains three hydrophilic hydroxyl groups, which are responsible for its solubility in water and its hygroscopic nature. Glycerin is believed to give bubbles their strength and may help lengthen the lifespan of the bubbles. The glycerin may also help to evenly distribute the colorant throughout the bubbles. In a preferred embodiment, the glycerin is present in an amount ranging from about 1 wt. % to about 20 wt. %, more preferably about 3 to 12 wt. %, even more preferably about 5 to 10 wt. %.

The colored bubble composition may comprise at least one water soluble polymer. As the name implies, water soluble polymers are polymers that are readily dissolvable, swellable, or soluble in aqueous environments. Any suitable water soluble polymer may be used in the present invention. For example, water soluble polymers may include urethanes, acrylates, epoxies, polyether polymers, cellulose derivatives, vinyl polymers, polyimides, polyamines, and mixtures thereof. In an exemplary embodiment, the at least one water soluble polymer is selected from the group consisting of hydroxyethyl cellulose (HEC) polymers, polyethylene oxide (PEO) polymers, and mixtures thereof. Water soluble polymers may be included in the bubble compositions in amounts ranging from about 0.1% to about 20% by weight, more particularly from about 1% to about 10% by weight. The water soluble polymer may also function as a surfactant.

The colored bubble composition may comprise at least one surfactant, which is the water soluble polymer or is in addition to the water soluble polymer. Suitable surfactants may include anionic, cationic, nonionic, zwitterionic compounds, and combinations thereof. The surfactant may be polymeric or non-polymeric. Surfactants are generally known to those of ordinary skill in the art. One or more surfactants may be used in the present invention.

Cationic surfactants may include long chain hydrocarbons which contain quaternarized heteroatoms, such as nitrogen. Suitable cationic surfactants may include quaternary ammonium compounds in which typically one of the groups linked to the nitrogen atom is a C₁₂-C₁₈ alkyl group and the other three groups are short chained alkyl groups. For example, cationic surfactants may include cetyl trimethylammonium bromide (CTAB), cetylpyridinium chloride (CPC), polyethoxylated tallow amine (POEA), benzalkonium chloride (BAC), benzethonium chloride (BZT), etc.

Anionic surfactants (amphiphatic agents) may include linear sodium alkyl benzene sulfonate (LAS), linear alkyl sulfates and phosphates, such as sodium lauryl sulfate (SLS) and linear alkyl ethoxy sulfates. Additional examples of anionic surfactants include substituted ammonium (e.g., mono-, di-, and tri-ethanolammonium), alkali metal and alkaline earth metal salts of C₆-C₂₀ fatty acids and rosin acids, linear and branched alkyl benzene sulfonates, alkyl ether sulfates, alkane sulfonates, sulfosuccinates, olefin sulfonates, hydroxyalkane sulfonates, fatty acid monoglyceride sulfates, alkyl glyceryl ether sulfates, acyl sarcosinates, acyl N-methyltaurides, and alkylaryl sulfonated surfactants, such as alkylbenezene sulfonates.

Nonionic surfactants may include polyhydroxy (polyhydric) compounds, such as ethylene glycol, butylene glycol, 1,3-butylene glycol, propylene glycol, glycerin (i.e., glycerine or glycerol), 2-methyl-1,3-propane diol, mannitol, corn syrup, beta-cyclodextrin, and amylodextrin; polyalkyloxy compounds, such as diethylene glycol, dipropylene glycol, polyethylene glycols, polypropylene glycols, and glycol derivatives; linear and branched ethoxylated alcohols; linear and branched, primary and secondary ethoxylated, propoxylated alcohols; linear and branched alkylphenoxy (polyethoxy) alcohols; polyethylene oxide esters; polyoxyethylene carboxylic acid esters; fatty acid glycerol esters; and fatty acid and ethoxylated fatty acid alkanolamides. Semi-polar nonionic surfactants like amine oxides, phosphine oxides, sulfoxides, and their ethoxylated derivatives are also included within the scope of the invention.

Suitable amphoteric and zwitterionic surfactants may include amino carboxylic acids and their salts, amino dicarboxylic acids and their salts, alkylbetaines, alkyl aminopropylbetaines, sulfobetaines, alkyl imidazolinium derivatives, certain quaternary ammonium compounds, certain quaternary phosphonium compounds and tertiary sulfonium compounds.

In one embodiment, the surfactant is selected from the group consisting of alkamine oxides, ethoxylates, celluloses, phosphate esters, polyethylene oxide esters, sulfosuccinates, and derivatives and mixtures thereof. For example, the surfactant may be an alkamine oxide with a C8-C22 alkyl group, such as dihydroxyethyl cocamine oxide; an ethoxylate, such as octyl phenol ethylene oxide; a cellulose ether, such as hydroxyethyl cellulose; a phosphate ester, such as a sodium or potassium phosphate ester or co-ester; a polyethylene oxide ester, such as polyoxyethylene octyl phenyl ether; and a sulfosuccinate, such as sodium dioctyl sulfosuccinate. In an exemplary embodiment, the cellulose is a cellulose ether selected from the group consisting of hydroxyethyl cellulose (HEC), hydroxypropyl cellulose (HPC), carboxymethylcellulose (CMC), methyl cellulose (MC), ethyl hydroxyethyl cellulose (EHEC), methyl hydroxyethyl cellulose (MHEC), hydrophobically modified hydroxyethyl cellulose (HMHEC), hydrophobically modified ethyl hydroxyethyl cellulose (HMEHEC), hydrophobically modified methyl hydroxyethyl cellulose (HMMHEC), ethyl cellulose (EC), methyl hydroxypropyl cellulose (MHPC), carboxymethyl hydroxyethyl cellulose (CMHEC), and mixtures thereof.

In an exemplary embodiment, the colored bubble composition comprises at least a second surfactant. In a preferred embodiment, the second surfactant is cellulose, most preferably hydroxyethyl cellulose. In one embodiment of the present invention, the cellulose is added to a heated mixture of water and glycerin (the humectant), which aids in dissolving the cellulose. In another embodiment, the colored bubble composition does not comprise any cellulose. In an exemplary embodiment, the colored bubble composition comprises an alkamine oxide and an ethoxylate (e.g., dihydroxyethyl cocamine oxide and octyl phenol ethylene oxide). In a preferred embodiment, the surfactant in the colored bubble composition consists of dihydroxyethyl cocamine oxide and octyl phenol ethylene oxide.

Surfactants may be included in the bubble compositions in amounts ranging from about 0.1% to about 50% by weight, more particularly from about 3% to about 30% by weight, and preferably from about 5% to about 15% by weight. Typically, greater amounts of surfactant results in longer-lasting bubbles.

The colored bubble composition comprises at least one colorant. Any suitable colorant or colorants may be selected from known dye and pigments classes that include, but are not limited to, acid dyes, food dyes (FD&C), cosmetic dyes (D&C), polymeric dyes, fluorescent dyes, pigments, azo dyes, etc. Dyes may include, for example, acid dyes, basic dyes, direct dyes, reactive dyes, sulfur dyes, fluorescent dyes, food dyes (FD&C), cosmetic dyes (D&C), solvent dyes, polymeric dyes, azo dyes, etc. Any suitable color or colors, such as red, pink, blue, green, purple, rainbow, etc., may be formed from the one or more colorants.

“Acid dyes” or “acidic dyes,” “base dyes” or “basic dyes,” “pH indicator dyes,” “direct dyes,” “reactive dyes,” “sulfur dyes,” “fluorescent dyes,” “solvent dyes,” “FD&C colorant,” “D&C colorant,” “polymeric colorant,” “azo dyes,” and “pigments” are all widely recognized by those skilled in the art. Generally, acid dyes have functional groups such as azo, triaryl methane, or anthraquinone that include acid substituents, such as nitro, carboxy or sulfonic acid groups; basic dyes have functional groups, such as sulfonium, oxonium, or quaternary ammonium functional groups; pH indicator dyes may include halochromic compounds; reactive dyes may contain a reactive group, for example, a haloheterocycle or an activated double bond; sulfur dyes may contain sulfide linkages; FD&C colorants are certified by the Federal Food, Drug & Cosmetic (FD&C) Act; D&C (Drug & Cosmetics) color additives have applications in drug & cosmetics; polymeric colorants include intermediate or high molar mass compounds that are intrinsically colored; and azo dyes include, for example, aryl azo compounds.

Any acid dye, base dye, pH indicator dyes, direct dye, reactive dye, sulfur dye, fluorescent dye, solvent dye, FD&C colorant, D&C colorant, polymeric colorant, azo dye, pigment, etc. readily ascertainable by those skilled in the art in any color, pH, etc. may be suitable for use in the bubble compositions of the present invention.

The colorant may be in any suitable form, such as solid phase or liquid form. The bubble composition may include one or more colorants of any type depending on the color, hue, and/or saturation desired in the colored bubble. In an exemplary embodiment, the colorant is selected from the group consisting of pH indicator dyes, acid dyes, FD&C dyes, food dyes, polymeric dyes, fluorescent dyes, azo dyes, pigments, and combinations thereof. In a preferred embodiment, the colorant is a pH indicator dye. In another preferred embodiment, the colorant is a washable dye.

Colorants (e.g., dyes and pigments) may be included in the bubble compositions in amounts ranging from about 0.1% to about 50% by weight, more particularly from about 3% to about 30% by weight, and preferably from about 5% to about 15% by weight.

In an exemplary embodiment, the colorant selected, such as a pH indicator dye, is able to wash away easily from most or all surfaces using water (e.g., a washable dye). In particular, the colored bubble compositions washed away easily from glass, metal, sidewalk, driveway, and painted wall surfaces, for example. Some of the colored bubble compositions also washed away easily from cement and fabric, such as acetate, Arnel, Verel, viscose, cotton, silk, wool, Creslan, Dacron, Nylon, Orlon etc. Some colorants may become colorless upon exposure to water. In other words, the colorant, such as pH indicator dyes, may be colorless in the protonated form.

Other additives may be added to the colored bubble compositions including, but not limited to, preservatives, fragrances, dye blockers, cleaners, viscosity-inducing components, thickening agents, bubble-stabilizing agents, sugars, pH adjusters, etc.

Preservatives include, but are not limited to, isothiazolinones, glutaraldehyde, bicyclic oxazolidones, hydroxybenzoic acid esters, 3-iodo-2-propynyl butyl carbamate, methyl p-hydroxybenzoate, and biocides comprising 2-methyl-4-isothiazolin-3-one and 5-chloro-2-methyl-4-isothiazolin-3-one. The preservatives may function as both a bactericide and a fungicide. In an exemplary embodiment, the preservatives are selected from the group consisting of isothiazolinones, bronopol (2-bromo-2-nitropropan-1,3-diol), and mixtures thereof. Preservatives, when present, may be present in amounts ranging from about 0.01% to about 6% by weight.

Fragrances or perfumes may include, for example, any odiferous compounds, such as natural or synthetic products (e.g., of the ester, ether, aldehyde, ketone, alcohol and hydrocarbon type). Natural fragrances may include, for example, citrus, rose, mint, or any other suitable types. Synthetic fragrances may be of any type, but often those desirable to children are preferred, such as bubble gum, candy, etc. A fragrance, when present, may be present in amounts ranging from about 0.01% to about 10% by weight.

Dye blockers or cleaners may be optionally added to the bubble compositions to inhibit staining or remove dye from surfaces, such as fabric, etc. Dye blockers may include, for example, sodium octane sulfonate, sodium xylenesulfonate, fatty alcohol ethoxylate, disodium hexadecyldiphenyloxide disulfonate, benzene-1,1-oxybis-tetrapropylene sulfonated sodium, decyl-sulfophenoxy-benzenesulfonic acid-disodium, decyl-sulfophenoxybenzenesulfonicacid disodium, octylphenoxypolyethoxyethanol, sodium salt of naphthalene-formaldehyde condensate, sodium salt of carboxylated polyelectrolyte, sodium lignin sulfonate, polyethoxylated tert-dodecyl sulfur compound, etc. Dye blockers or cleaners, when present, may be present in any amount but may be effective in amounts ranging from about 0.01% up to about 30% by weight.

Viscosity-inducing components and thickeners may be added to increase the viscosity of the bubble composition and stabilize the bubbles. Viscosity components, if present, may be present in an amount of about 0.01 to 25 wt. %. Bubble-stabilizing agents may include, sugars, polysaccharides, polysaccharide derivatives, proteins, etc. Sugars may include saccharides, such as sucrose, maltose, lactose, glucose, fructose, galactose, etc. Polysaccharide derivatives may include, for example, starch, gelatin, carboxymethyl cellulose, methyl cellulose, ethyl methyl cellulose, guar gum, gum arabic, etc. Bubble-stabilizing agents may be present in amounts from about 0 to 20 wt. %.

The pH of the composition may be adjusted as desired. A higher pH, e.g., about 10-11, may be desirable to improve the color strength. For example, the pH may be adjusted with an acid, such as phosphoric acid, sulfuric acid, etc. or a base, such as sodium hydroxide. Any suitable pH adjuster may be included in any suitable amount. For example, pH adjusting agents may be present in amounts from about 0 to 5 wt. %. In an exemplary embodiment, the initial pH of the colored bubble composition ranges from about 6.5 to about 11. The pH may also vary when a pH indicator dye is used. For example, a pH indicator dye may absorb carbon dioxide from the atmosphere to form carbonic acid, which lowers the pH of the bubble solution. Also, some pH indicator dyes may become colorless under certain conditions, such as at a certain pH or when exposed to water. Thus, there may be some pH sensitivity based on the colorant(s) selected.

Small amounts of organic solvents may also be added to the bubble compositions provided that they are substantially non-reactive with the other ingredients in the bubble compositions. Water-miscible organic solvents, such as alcohols, glycol ethers, and glycols, may be especially suitable.

In an exemplary embodiment of the present invention, the colored bubble composition comprises about 70 to 95 wt. % water (more particularly about 75 to 85 wt. %); about 2 to 15 wt. % of the at least one humectant, such as glycerin (more particularly about 5 to 10 wt. %); about 0.01 to 10 wt. % of the at least one water soluble polymer and/or the at least one surfactant, such as hydroxyethyl cellulose and/or a phosphate ester (more particularly about 1 to 5 wt. %); and about 0.01 to 15 wt. % of the at least one colorant, such as a pH indicator dye (more particularly about 4 to 10 wt. %).

It is preferred that each of the ingredients used in the bubble composition are non-toxic, non-irritating, non-staining, washable, and/or edible so that the bubble solution is suitable for use by children. Each of the ingredients may come in any suitable and obtainable form, such as neat, dilute, aqueous, solid, etc.

In one embodiment of the present invention, a colored bubble composition for producing colored bubbles is obtained by: mixing water, at least one humectant, and at least one water soluble polymer to form a mixture, wherein the mixture does not comprise a colorant; subsequently, adding at least one colorant to the mixture.

For example, the colored bubbles may be obtained by: (1) adding hot water (e.g., about 100° F.-120° F.) to a container; (2) adding and mixing a water soluble polymer to the hot water until dissolved; (3) adding and mixing other ingredients to the mixture, except the colorant; and (4) adding and mixing the colorant or colorants to the mixture. In this embodiment, the mixture is not heated, but the hot water allows the water soluble polymer, such as hydroxyethyl cellulose, to dissolve. Afterwards, the other ingredients such as glycerin and other optional ingredients may be added. After all of the other ingredients have been incorporated, then the colorant is blended into the mixture.

In another embodiment, the colored bubbles may be obtained by: (1) mixing together a humectant, such as glycerin, and a water soluble polymer; (2) adding water and mixing all ingredients are dissolved; (3) adding any other ingredients, except the colorant; and (4) adding and mixing the colorant or colorants into the mixture. In this embodiment, the mixture is not heated because of the water soluble polymer selected. In other words some water soluble polymers, such as polyethylene oxide polymers, do not require heating to dissolve. Accordingly, the glycerin and polyethylene oxide polymer may be mixed at room temperature. Then, water may be added to the glycerin/polyethylene oxide polymer mixture. Other optional ingredients may also be added. After all of the other ingredients have been incorporated, then the colorant is blended into the mixture.

In another embodiment of the present invention, a colored bubble composition for producing colored bubbles is obtained by: (1) heating a mixture of water and at least one humectant; (2) cooling the mixture; (3) adding at least one surfactant to the mixture; and (4) adding at least one colorant to the mixture after the mixture has cooled to about 20 to 30° C.

For example, a mixture of water, at least one humectant, such as glycerin, and an optional surfactant, such as cellulose, is heated. In other words, the ingredients are not necessarily merely mixed together at room temperature. The mixture of at least water and a humectant is heated above room temperature. The mixture may be heated using any suitable equipment known in the art, for example, by direct or indirect heating of a vessel or reactor. The mixture may also be well mixed using suitable equipment, such as a paddle mixer, ribbon blender, etc., and techniques known to those of ordinary skill in the art. The ingredients may be mixed until all constituents are dissolved in the water and an aqueous solution results.

In an exemplary embodiment, the mixture of water and at least one humectant is heated to a temperature in the range of about 30 to 70° C., preferably about 40 to 60° C., more preferably to about 45 to 55° C., most preferably about 50° C. The temperature of the mixture desired may depend on the ingredients present. For example, if the mixture consists only of glycerin and water, the mixture may be heated to a lower temperature in the range of about 30 to 45° C. If the mixture consists of glycerin, water, and a surfactant, such as cellulose, then the mixture may be heated to a higher temperature of about 45 to 55° C. to ensure dissolution of the ingredients.

The mixture may be heated for an effective period of time to heat the mixture to the desired temperature. In an exemplary embodiment, the mixture is heated for less than 30 minutes, preferably less than 20 minutes, more preferably for about 15 minutes.

Second, the mixture is cooled. The mixture may be cooled using any suitable equipment, such as a heat exchanger, or using techniques generally known in the art. Alternatively, the mixture may be simply removed from the heating source and allowed to cool to about ambient/room temperature. The mixture may be agitated during cooling to facilitate heat transfer. In an exemplary embodiment, the mixture is immediately cooled once it has reached the desired temperature during the heating step.

Third, at least one surfactant is added to the mixture. The surfactant may be added to the water and humectant mixture during heating, while the mixture is cooling, or after the mixture has cooled, for example, to about 20 to 30° C. In one embodiment of the present invention, the at least one surfactant is added to the mixture once the mixture has cooled to about 20 to 30° C. or to about room temperature. In an exemplary embodiment, a surfactant, such as cellulose, is added to the mixture of water and at least one humectant while the mixture is heated, and a to second surfactant, such as a phosphate ester, is added to the mixture once it has cooled to about room temperature.

Fourth, at least one colorant is added to the mixture after the mixture has cooled, for example, to about 20 to 30° C. (more particularly about 23 to 27° C.). In an exemplary embodiment, the at least one colorant is added to the mixture after the mixture has cooled to about 25° C. (e.g., about room temperature). In another embodiment of the present invention, at least one additional ingredient, such as preservatives, wetting agents, foam enhancers, pH adjusters, etc., is also added to the mixture when the mixture has cooled to about 20 to 30° C. In a preferred embodiment, the at least one colorant is the last ingredient added to the cooled mixture. Once all of the ingredients have been added and the mixture has been cooled, e.g., to about 20 to 30° C. or preferably about 25° C., only then is the colorant added. In other words, the colorant need not and is not heated nor combined with the other ingredients while the mixture is heated. Thus, the colorant readily disperses in the mixture without requiring an elevated temperature.

In one embodiment of the present invention, a method of making a colored bubble composition for producing colored bubbles comprises heating a mixture of water and at least one humectant. Subsequently, the mixture is cooled. At least one surfactant is added to the mixture during heating, during cooling, or once cooled to about room temperature. Preferably, one surfactant is added during heating and another surfactant is added after the mixture has cooled. After the mixture has cooled to about 20 to 30° C., at least one colorant is added to the mixture (e.g., as the last ingredient).

In another embodiment according to the present invention, a method of making a colored bubble composition for producing colored bubbles comprises heating a mixture of water, at least one humectant, such as glycerin, and optionally a surfactant, such as cellulose, to a temperature in the range of about 30 to 70° C., more preferably 40 to 60° C. Subsequently, the mixture is cooled to a temperature in the range of about 20 to 30° C. At least one surfactant and at least one colorant are then added to the cooled mixture.

By adding the color last, it was found that the bubble solutions obtained from the methods according to the present invention were more stable and the colorant remained dispersed throughout the bubble solution for a longer period of time as compared to bubble solutions of the prior art. In particular, after one month of ageing, the color intensity of the bubble solutions were substantially maintained. In other words, the color intensity was not greatly diminished over time. Thus, the bubble solutions were stable for at least one month in duration. Similarly, blue and purple solutions according to the invention were shown to exhibit at least one year stability.

The colored bubble composition may be bottled and stored as appropriate. The colored bubble composition may be formed into a colored bubble using a suitable bubble-making device known in the art. The bubble compositions of the present invention may be used with any simple or complex bubble making device, apparatus, or machine to generate the colored bubbles. The colored bubbles may vary from translucent to opaque. Preferably, the colored bubbles are evenly colored bubbles having a saturated and rich hue of the selected color. The bubbles may form a colored circle or a dot on the surface when they burst depending on the water soluble polymer selected in the formulation. In either case, the broken colored bubbles may wash away easily with water.

### Examples

Colored bubble compositions A-X were prepared by mixing together and heating water, glycerin, and in some cases, cellulose, to a temperature of about 50° C. Subsequently, the mixtures were cooled to about 25° C. Additional ingredients, such as surfactants, preservatives, etc., were mixed in at 25° C. The last ingredient added and incorporated at 25° C. was the colorant or colorants.

Table 1 shows five colored bubble formulations according to the invention (B-F) and one traditional bubble composition (A) without colorant (clear). Each of the ingredients and the weight percentage of each ingredient used in each formulation are listed in the tables. CELLOSIZE™ QP40 hydroxyethyl cellulose (HEC) is a low molecular weight cellulosic polymer obtainable from Dow Chemical Company with headquarters in Midland, Mich. MACAT® AO-12-2 is a 30% active dihydroxyethyl cocamine oxide in water (wetting agent, foam booster, and stabilizer) obtainable from Mason Chemical Company with offices in Arlington Heights, Ill. TRITON X-100 is a nonionic surfactant, octyl phenol ethylene oxide, which has a hydrophilic polyethylene oxide group (on average it has 9.5 ethylene oxide units) and a hydrocarbon lipophilic or hydrophobic group obtainable from Dow Chemical Company. SPECTRA RINSE products are colorants/rinsing dyes of the color indicated obtainable from Spectra Colors Corp. with offices in Kearney, N.J. XIAMEN products are colorants/pH indicator dyes obtainable from Xiamen Yonghengguan Industry & Trade Co. Ltd. with offices in Xiamen, China. KATHON™ PFM (isothiazolinones) is a preservative obtainable from Dow Chemical Company. REPUTAIN™ B30 is a preservative, 30% solution of 2-bromo-2-nitropropane-1,3-diol in propylene glycol, obtainable from Arch Chemicals, Inc. headquartered in Norwalk, Conn.

TABLE 1
Colored Bubbles

| | A | B | C | D | E | F |
|---|---|---|---|---|---|---|
| Color | Clear | Orange | Blue | Green | Purple | Pink |
| Water | 91.36 | 82.46 | 82.46 | 82.46 | 82.46 | 82.46 |
| Glycerin | 5 | 5 | 5 | 5 | 5 | 5 |
| CELLOSIZE ™ QP40 | 1.66 | 1.66 | 1.66 | 1.66 | 1.66 | 1.66 |
| MACAT ® AO-12-2 | 1.4 | 1.4 | 1.4 | 1.4 | 1.4 | 1.4 |
| TRITON X-100 | 0.2 | 0.1 | 0.1 | 0.1 | 0.1 | 0.1 |
| SPECTRA RINSE, | | 9 | | | | |
| Orange-C LIQ | | | | | | |
| SPECTRA RINSE, | | | 9 | | | |
| Blue-T 13X LQ | | | | | | |
| SPECTRA RINSE, Green | | | | 9 | | |
| XIAMEN E5, 081709 | | | | | 9 | |
| XIAMEN E4, 070909 | | | | | | 9 |
| KATHON ™ PFM | 0.08 | 0.08 | 0.08 | 0.08 | 0.08 | 0.08 |
| REPUTAIN ™ B30 | 0.3 | 0.3 | 0.3 | 0.3 | 0.3 | 0.3 |
| Total | 100 | 100 | 100 | 100 | 100 | 100 |

Table 2 shows additional colored bubble formulations (G-M) according to the invention. In addition to the ingredients previously listed above, POLYOX™ WSR 205 is a nonionic water-soluble polymer obtainable from Dow Chemical Company. STRODEX© compositions are phosphate ester surfactants obtainable from Ashland Aqualon with offices in Wilmington, Del.

TABLE 2
Colored Bubbles

| | G | H | I | J | K | L | M |
|---|---|---|---|---|---|---|---|
| Color | Blue | Blue | Green | Green | Red | Red | Purple |
| Water | 78.32 | 72.72 | 78.32 | 72.72 | 78.12 | 74.52 | 78.92 |
| POLYOX ™ WSR 205 | 1.6 | 1.6 | 1.6 | 1.6 | 1.6 | 1.6 | 1.6 |
| Glycerin | 9.3 | 9.3 | 9.3 | 9.3 | 9.3 | 9.3 | 9.3 |
| MACAT ® AO-12-2 | 1.4 | | 1.4 | | 1.4 | | |
| STRODEX © Super V-8 | | 4 | | 4 | | 4 | |
| STRODEX © PK90 | | | | | | | 0.6 |
| TRITON X-100 | | | | | | | |
| SPECTRA RINSE, | 9 | 12 | 4.5 | 6 | | | |
| Blue-T 13X LQ | | | | | | | |
| SPECTRA RINSE, | | | 4.5 | 6 | | | |
| Yellow-R12X LQ | | | | | | | |
| XIAMEN, E1 Red | | | | | 9 | 10 | |
| XIAMEN, E2 Purple | | | | | | | 9 |
| Phosphoric acid, 62% | | | | | 0.2 | 0.2 | 0.2 |
| KATHON ™ LX 1.5% | 0.08 | 0.08 | 0.08 | 0.08 | 0.08 | 0.08 | 0.08 |
| REPUTAIN ™ B30 | 0.3 | 0.3 | 0.3 | 0.3 | 0.3 | 0.3 | 0.3 |
| Total | 100 | 100 | 100 | 100 | 100 | 100 | 100 |
| Initial pH | 8.5 | 8.5 | 8.4 | 8.3 | 10.9 | 10.95 | 10.9 |

Table 3 shows five colored bubble formulations (N-R) according to the invention and two traditional bubble compositions (S and T) without colorant (clear).

TABLE 3
Colored Bubbles

| | N | O | P | Q | R | S | T |
|---|---|---|---|---|---|---|---|
| Color | Purple | Blue | Green | Red | Purple | Clear | Clear |
| Water | 75.52 | 78.12 | 78.12 | 77.92 | 77.92 | 82.72 | 85.32 |
| POLYOX ™ WSR 205 | 1.6 | 1.6 | 1.6 | 1.6 | 1.6 | 1.6 | 1.6 |
| Glycerin | 9.3 | 9.3 | 9.3 | 9.3 | 9.3 | 10.3 | 10.3 |
| MACAT ® AO-12-2 | | 1.4 | 1.4 | 1.4 | 1.4 | | 1.4 |
| STRODEX © Super V-8 | 4 | | | | | 4 | |
| STRODEX © PK90 | | | | | | | |
| TRITON X-100 | | 0.2 | 0.2 | 0.2 | 0.2 | 1 | 1 |
| SPECTRA RINSE, | | 9 | 4.5 | | | | |
| Blue-T 13X LQ | | | | | | | |
| SPECTRA RINSE, | | | 4.5 | | | | |
| Yellow-R12X LQ | | | | | | | |
| XIAMEN, E1 Red | | | | 9 | | | |
| XIAMEN, E2 Purple | 9 | | | | 9 | | |
| Phosphoric acid, 62% | 0.2 | | | 0.2 | 0.2 | | |
| KATHON ™ LX 1.5% | 0.08 | 0.08 | 0.08 | 0.08 | 0.08 | 0.08 | 0.08 |
| REPUTAIN ™ B30 | 0.3 | 0.3 | 0.3 | 0.3 | 0.3 | 0.3 | 0.3 |
| Total | 100 | 100 | 100 | 100 | 100 | 100 | 100 |
| Initial pH | 10.95 | 8.5 | 8.4 | 10.95 | 10.95 | 7.6 | 9.4 |

Table 4 shows four colored bubble formulations (U-X) according to the invention. In addition to the ingredients previously listed above, HI-MAR is a wetting agent/anionic surfactant (sodium dioctyl sulfosuccinate in an ethanol-water solution) obtainable from Hi-Mar Specialty Chemicals, LLC with offices in Milwaukee, Wis.

TABLE 4

| Colored Bubbles | U | V | W | X |
|---|---|---|---|---|
| Color | rainbow | blue | green | purple |
| Water | 81.8 | 72.4 | 72.4 | 72.4 |
| Glycerin | 8 | 8.8 | 8.8 | 8.8 |
| POLYOX ™ WSR 205 | 1.4 | 1.9 | 1.9 | 1.9 |
| Sugar | 6.4 | | | |
| TRITON X-100 | 1 | 0.9 | 0.9 | 0.9 |
| HI-MAR DOS | 1.4 | | | |
| STRODEX © Super V-8 | | 6 | 6 | 6 |
| SPECTRA RINSE, Blue- T LIQ | | 10 | | |
| SPECTRA RINSE, Green X LIQ | | | 10 | |
| XIAMEN HIP concentrate | | | | 10 |
| Total | 100 | 100 | 100 | 100 |
| pH | 7-8 | 7-8 | 7-8 | 11 |

Table 5 shows six colored bubble formulations (Y-DD) according to embodiments of the invention. Compositions Y-AA were prepared as follows: Hot water (about 100° F.-120° F.) was added to a container and mixed. CELLOSIZE™ QP40 was added to the hot water and was mixed until dissolved. All other ingredients were added, except the colorant. After mixing for about 2 minutes, the colorant or colorants are added and mixed for about 5 minutes. Compositions BB-DD were prepared by mixing glycerin and POLYOX™ together. Water was added and mixed until all components dissolved. All other ingredients were added, except the colorant. After mixing for about 2 minutes, the colorant or colorants were added and mixed for about 5 minutes. When the bubbles burst, the bubbles prepared with POLYOX™ left a colored circle on a surface, and the bubbles prepared with CELLOSIZE™ left a dot on the surface.

TABLE 5
Colored Bubbles

| | Y | Z | AA | BB | CC | DD |
|---|---|---|---|---|---|---|
| Color | Orange | Green | Blue | Purple | Pink | Blue |
| Hot tap water | 82.62 | 82.62 | 82.52 | | | |
| (about 100° F.-120° F.) | | | | | | |
| Tap water | | | | 84.92 | 86.42 | 82.52 |
| Glycerin | 5 | 5 | 5 | 5 | 5 | 5 |
| CELLOSIZE ™ Hydroxyethyl | 1.5 | 1.5 | 1.5 | | | |
| CELLOSIZE QP40 | | | | | | |
| POLYOX ™ WSR 205 | | | | 1.5 | 1.5 | 1.5 |
| KATHON ™ PFM | 0.08 | 0.08 | 0.08 | 0.08 | 0.08 | 0.08 |
| REPUTAIN ™ B30 | 0.3 | 0.3 | 0.3 | | | 0.3 |
| TRITON X-100 | 0.1 | 0.1 | 0.2 | 0.1 | 0.1 | 0.2 |
| MACAT ® AO-12-2 | 1.4 | 1.4 | 1.4 | 1.4 | 1.4 | 1.4 |
| SPECTRA RINSE, | 9 | | | | | |
| Orange-AU765 LQ | | | | | | |
| SPECTRA RINSE, | | | 9 | | | 9 |
| Blue-T 14X LQ | | | | | | |
| SPECTRA RINSE, | | 9 | | | | |
| Green AU767-LQ | | | | | | |
| XIAMEN E5 | | | | 7 | 3 | |
| XIAMEN E11 | | | | | 2.5 | |
| Total | 100 | 100 | 100 | 100 | 100 | 100 |

Table 6 shows five colored bubble formulations (EE-II) according to embodiments of the invention.

TABLE 6

| Colored Bubbles | EE | FF | GG | HH | II |
|---|---|---|---|---|---|
| | Purple | Blue | Green | Orange | Pink |
| Tap water | 84.62 | 86.62 | 84.62 | 82.62 | 82.62 |
| Glycerin | 5 | 5 | 5 | 5 | 5 |
| POLYOX ™ WSR 205 | 1.5 | 1.5 | 1.5 | 1.5 | 1.5 |
| KATHON ™ PFM | 0.08 | 0.08 | 0.08 | 0.08 | 0.08 |
| REPUTAIN ™ B30 | 0.3 | 0.3 | 0.3 | 0.3 | 0.3 |
| TRITON X-100 | 0.1 | 0.1 | 0.1 | 0.1 | 0.1 |
| MACAT ® AO-12-2 | 1.4 | 1.4 | 1.4 | 1.4 | 1.4 |
| SPECTRA RINSE, | | | | 9 | |
| Orange | | | | | |
| SPECTRA RINSE, Blue | | 5 | | | |
| SPECTRA RINSE, | | | 7 | | |
| Green | | | | | |
| XIAMEN E5 | 7 | | | | |
| SPECTRA RINSE Red | | | | | 9 |
| Total | 100 | 100 | 100 | 100 | 100 |
| Initial pH | 10.85 | 8.19 | 7.96 | 8.03 | 8.4 |
| Initial Viscosity, cps | 63 | 60 | 75 | 70 | 75 |

Table 7 shows stability data for colored bubble formulations produced in accordance with the present invention as compared to two competitive formulations. The pH, Brookfield viscosity (cP), relative amounts of bubbling, and color intensity were measured for each color and for the two competitive colors. The results were evaluated on an absent (A), low (L), medium (M), high (H) and very high (VH) scale based on the degree of bubbling and amount of color intensity observable. A sample of each color was placed in a 120° F. oven, while another sample of each color was maintained at room temperature. After 1 month, pH, viscosity, bubbling and color intensity were measured again. In addition, blue and purple solutions according to the invention were compared to the comparative blue and comparative purple after one year at room temperature. The comparative purple solution failed to exhibit any color after one year at room temperature, whereas the purple solution according to the invention maintained its color. This demonstrates good shelf life stability of the colored bubble solutions.

TABLE 7
Colored Bubbles

| | | | | | | Comp. | Comp. |
|---|---|---|---|---|---|---|---|
| | pink | green | orange | purple | blue | purple | Blue |
| Initial pH | 8.01 | 7.78 | 7.80 | 10.68 | 8.14 | 10.31 | 12.38 |
| Initial Viscosity | 55.0 | 55.0 | 54.0 | 60.0 | 55.0 | 1.5 | 1.5 |
| Initial Bubbling | H | H | H | H | H | L | H |
| Initial Color intensity | M | H | M | H | H | H | H |
| 1 month RT pH | 7.63 | 7.42 | 7.39 | 10.30 | 7.89 | 10.13 | 12.20 |
| 1 month RT Viscosity | 29.5 | 33.5 | 29.5 | 41.0 | 36.0 | 1.5 | 1.5 |
| 1 month RT Bubbling | H | H | H | H | H | M | M |
| 1 month RT Color | L | H | L | H | H | M | H |
| intensity | | | | | | | |
| 1 month 120 F. pH | 7.70 | 7.29 | 7.41 | 10.55 | 7.81 | 10.20 | 12.40 |
| 1 month 120 F. | 14.0 | 19.5 | 11.0 | 51.5 | 44.0 | 1.5 | 1.5 |
| Viscosity | | | | | | | |
| 1 month 120 F. | M | H | M | H | VH | Low | M |
| Bubbling | | | | | | | |
| 1 month 120 F. Color | M | H | M | H | H | M | H |
| intensity | | | | | | | |
| Freeze-Thaw pH | 7.92 | 7.72 | 7.70 | 10.69 | 8.17 | 10.28 | 12.26 |
| Freeze-Thaw | 22.0 | 17.5 | 30.0 | 17.0 | 20.0 | 1.5 | 1.5 |
| Viscosity | | | | | | | |
| Freeze-Thaw | M | M | M | M | H | L | L |
| Bubbling | | | | | | | |
| Freeze-Thaw Color | H | H | L | VH | H | M | VH |
| intensity | | | | | | | |
| 1 year RT pH | | | | 10.35 | 8.05 | 9.45 | 12.31 |
| 1 year Color intensity | | | | H | H | A | H |

The colored bubble compositions described herein produced colored bubbles that were richly colored in each of the colors indicated in the examples. When the bubbles were broken, the colored solution was easily washed away with water. In particular, the orange, green, and blue bubble colors were found to wash away easily with water, but did not disappear or change to colorless based on pH. The pink and purple bubbles, however, turned colorless or disappeared when exposed to water due to the pH indicator dyes selected. In particular, the purple and pink bubbles turned colorless when the pH was below about 9, e.g., when exposed to water. Additionally, the color intensity of the purple and pink bubbles may be slightly reduced if exposed to atmospheric carbon dioxide (e.g., if the container is not well sealed). In other words, the pH of the bubble solution may also decrease from absorption of atmospheric carbon dioxide. The pink, purple, and orange bubbles were found to be completely washable from all surfaces tested. Blue and green bubbles were found to be completely washable from glass, metal, sidewalk, driveway, and painted wall surfaces. While there was some slight staining, the blue and green bubbles were also washable from uncoated pressure treated wood, cement bricks, t-shirt fabric, and a swatch of different types of fabrics, including acetate, Arnel, bleached cotton, silk, Verel, Viscose and wool, Creslan, Dacron, Nylon, and Orlon.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A colored bubble composition for producing colored bubbles obtained by:
mixing water, at least one humectant, and at least one water soluble polymer to form a mixture, wherein the mixture does not comprise a colorant;
subsequently, adding at least one colorant to the mixture.

2. A colored bubble composition according to claim 1, wherein the at least one humectant is glycerin.

3. A colored bubble composition according to claim 1, wherein the at least one water soluble polymer is selected from the group consisting of hydroxyethyl cellulose (HEC) polymers, polyethylene oxide polymers, and mixtures thereof.

4. A colored bubble composition according to claim 1, wherein the humectant and at least one water soluble polymer are mixed, and subsequently, the water is added to form the mixture.

5. A colored bubble composition according to claim 1, wherein the colorant is selected from the group consisting of pH indicator dyes, acid dyes, FD&C dyes, food dyes, polymeric dyes, fluorescent dyes, azo dyes, pigments, and combinations thereof.

6. A colored bubble composition according to claim 1 further comprising at least one additional ingredient added to the mixture prior to adding the at least one colorant, wherein the additional ingredient is selected from the group consisting of preservatives, wetting agents, foam enhancers, and mixtures thereof.

7. A colored bubble composition for producing colored bubbles obtained by:
heating a mixture of water and an ingredient selected from the group consisting of water soluble polymers, humectants, and mixtures thereof;
cooling the mixture;
adding at least one surfactant to the mixture; and
adding at least one colorant to the mixture after the mixture has cooled to about 20 to 30° C.

8. A colored bubble composition according to claim 7, wherein a surfactant is added to the mixture during the heating step.

9. A colored bubble composition according to claim 8, wherein the surfactant is an alkamine oxide, an ethoxylate, and mixtures thereof.

10. A colored bubble composition according to claim 8, wherein the surfactant is a cellulose ether selected from the group consisting of hydroxyethyl cellulose (HEC), hydroxypropyl cellulose (HPC), carboxymethylcellulose (CMC), methyl cellulose (MC), ethyl hydroxyethyl cellulose (EHEC), methyl hydroxyethyl cellulose (MHEC), hydrophobically modified hydroxyethyl cellulose (HMHEC), hydrophobically modified ethyl hydroxyethyl cellulose (HMEHEC), hydrophobically modified methyl hydroxyethyl cellulose (HMMHEC), ethyl cellulose (EC), methyl hydroxypropyl cellulose (MHPC), and carboxymethyl hydroxyethyl cellulose (CMHEC).

11. A colored bubble composition according to claim 7, wherein the mixture is heated for less than 30 minutes.

12. A colored bubble composition according to claim 7, wherein the mixture is heated to a temperature in the range of about 30 to 70° C.

13. A colored bubble composition according to claim 12, wherein subsequent to reaching the temperature, the mixture is cooled immediately.

14. A colored bubble composition according to claim 7, wherein the at least one surfactant is added to the mixture once the mixture has cooled to about 20 to 30° C.

15. A colored bubble composition according to claim 14, wherein at least one additional ingredient is added after the mixture has cooled to about 20 to 30° C.

16. A colored bubble composition according to claim 7, wherein the at least one colorant is added to the mixture after the mixture has cooled to about 25° C.

17. A colored bubble composition according to claim 1, wherein the colored bubble composition comprises about 70 to 95 wt. % water; about 2 to 15 wt. % of the at least one humectant; about 0.01 to 10 wt. % of the at least one water soluble polymer; and about 0.01 to 15 wt. % of the at least one colorant.

18. A colored bubble composition according to claim 1, wherein the colored bubble composition is formed into a colored bubble.

19. A colored bubble composition according to claim 1, wherein the colored bubble composition is stable for at least one month.

20. A method of making a colored bubble composition for producing colored bubbles comprising:
mixing water, at least one humectant, and at least one water soluble polymer to form a mixture, wherein the mixture does not comprise a colorant;
subsequently, adding at least one colorant to the mixture.

21. A method of making a colored bubble composition for producing colored bubbles according to claim 20, wherein the water and the at least one water soluble polymer are mixed and heated to a temperature in the range of about 45 to 120° C.;
subsequently, the at least one humectant and, optionally, at least one additional ingredient is added after the mixture has cooled to a temperature in the range of about 20 to 30° C.; and
subsequently, the at least one colorant is added to the cooled mixture.

22. A method of making a colored bubble composition according to claim 20, wherein the at least one humectant and the at least one water soluble polymer are mixed together; and
subsequently, the water and, optionally, at least one additional ingredient is added.
